(19) United States
(12) Patent Application Publication
(10) Pub. No.: US 2006/0075055 A1
(43) Pub. Date: Apr. 6, 2006

(54) System and method for integration of instant messaging and virtual environment clients

(76) Inventor: Andrew Littlefield, San Francisco, CA (US)

Correspondence Address: FLIESLER MEYER, LLP, FOUR EMBARCADERO CENTER, SUITE 400, SAN FRANCISCO, CA, 94111, US

(21) Appl. No.: 11/244,850

(22) Filed: Oct. 6, 2005

Related U.S. Application Data
(60) Provisional application No. 60/616,494, filed on Oct. 6, 2004.

(51) Int. Cl. G06F 15/16; G06F 17/00

(52) U.S. Cl. 709/206; 715/753

(57) ABSTRACT

A system and method for integration of instant messaging and virtual environment clients. Users of instant messaging clients can participate in channel-based or conference-call-like conversations with multiple users simultaneously, without compromising the ease of use typically associated with those clients. The system allows for the integration of avatars and virtual environments via an external proxy server to manage chat sessions in the external messaging clients. The integration of avatars, virtual environments and messaging clients leverages real-world user experiences, and existing messaging clients, to provide a user model that is easier for the average user to understand and utilize.

### CLAIM OF PRIORITY

This application claims the benefit of U.S. Provisional Patent Application No. 60/616,494, entitled “SYSTEM AND METHOD FOR INTEGRATION OF INSTANT MESSAGING AND VIRTUAL ENVIRONMENT CLIENTS USING A PROXY SERVER”, (Attorney Docket No. EVTWS-01000US0), filed Oct. 6, 2004, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to instant messaging systems, online gaming environments, and interactive computing, and is specifically related to systems and methods for integration of instant messaging and virtual environment clients.

### BACKGROUND

In the context of online or distributed computing environments, the use of chatting or instant messaging has existed in one form or another for several years. The first instant messaging systems allowed users sharing the same computer to synchronously exchange messages. These systems were later expanded to allow users on different computers to exchange messages synchronously via a computer network. In more recent years there have been a number of projects focused on providing synchronous messaging capabilities across the Internet, and its precursor the ARPAnet. Many of these projects only supported a handful of users; however a couple of projects, such as the Bitnet Relay Chat, and the Internet Relay Chat (IRC) project developed by Jarkko Oikarinen, were sufficient to support thousands of users. The popularity of IRC can be linked to three factors:

Timing: The first release of IRC in 1988 allowed the messaging network, protocols and clients to mature before the Internet boom of the 1990's, allowing the network to scale with the upswing in usage that occurred with many Internet based technologies.

Ease of use: Compared to earlier messaging systems, IRC was substantially easier to use than it's precursors.

Channel Model: IRC was designed to be part of a Bulletin Board System (BBS) and supported user model of interest channels. Users could subscribe to a channel and then communicate synchronously with anyone else that had also subscribed to that channel, so enabling group conversations (similar to telephone conference calls). This dramatically expanded the user base of those that would be interested in using such a technology from the then-core user group of system administrators (who used messaging to discuss and resolve administrative problems in real-time with their colleagues in different locations), to technically savvy Internet users who used IRC to discuss a broader range of topics.

While the IRC network continued to flourish, in 1996 a group of engineers released ICQ (phonetically pronounced “I seek you”), an instant messaging product that would eventually eclipse the popularity of IRC. Within six months of its release, ICQ counted over 850,000 users, and a network capable of supporting hundreds of thousands of simultaneous users. The popularity of ICQ can be traced to the following factors:

Ease of use: While IRC had represented a step forward in terms of ease of use compared to it's predecessors, IRC clients were still comparatively complex and difficult to operate. In contrast the early ICQ clients were easier to use and well within the scope of complexity that the average computer user could manage.

The “Buddy List”: ICQ introduced an important innovation to the world of instant messaging in providing a stateful list that provided the online status (available, busy, in a meeting, etc) of various contacts that the user had already established, and that allowed chat sessions to be initiated by simply clicking on a contact name. This feature allowed users to determine the status of a user prior to attempting communication, and allowed users to initiate conversations with very little overhead.

Peer-to-Peer Architecture: The ICQ engineers designed the ICQ clients so that they were less reliant upon a central server or a single purpose network to route messages between users. Most of the data traffic associated with ICQ chat sessions occurs between the machines on which the ICQ client is running, rather than requiring a central server to route the message traffic (a requirement with IRC). This allowed the ICQ team to increase the number of users that ICQ network could support with only a very minimal incremental investment required in central network resources, so reducing the costs associated with running such a network.

Timing: As with the IRC network, the ICQ team were able to take advantage of the growth in the Internet user community during the 1990s. As the ICQ client was so easy to use, adoption was widespread, with instant messaging becoming the third largest Internet traffic driver by 2000 (just behind email), and had surpassed email to become the second largest traffic driver at the time of this writing.

The success of ICQ did not go unnoticed by the “Internet giants”, with America On-line (AOL) acquiring ICQ in 1997. Microsoft and Yahoo! also introduced instant messaging clients in 1997. At the time of writing AOL has maintained it's early lead in the IM market with an estimated 60 million registered users, while Microsoft and Yahoo! have an estimated 23 million users and 19 million users respectively.

As with instant messaging, virtual environments also have a long history. The earliest virtual environments can be traced back to 1978, when Roy Trubshaw introduced the first release of the Multi-User Dungeon (MUD) program. MUD was purely text based, relied upon textual descriptions of the virtual environments and characters, with users interacting via text commands also. FIG. 1 shows an example 100 of a MUD gaming session. MUD allowed multiple users (or game characters) to explore the same virtual world simultaneously. It also allowed characters to interact with each other in various formats, ranging from a conversation to a fight to the death. Users could interact with environmental objects, in which case the system provided stateful tracking of those objects (e.g. a player could drop a coin within a room, and should another player visit that same room at a later time they would be able to see that same coin and interact with it). The MUD program also allowed players to create their own virtual environments and game spaces using a built-in scripting language, allowing expansion of the virtual environment by end-users. This extensibility coupled with strong game-play elements proved to be very popular at the time of release, with several MUD deployments still in use today. More importantly, MUD provided the functional blueprints on which many virtual environments still utilize to this day.

The popularity of the original MUD did not go unnoticed by commercial vendors, who subsequently developed the second generation of virtual environments in the mid-1980s. This second generation of virtual worlds, leveraged the same text-based interaction model and the same basic game-play elements as MUD; however the second generation differed in terms of the scale of the virtual environments and the maximum number of simultaneous users that the virtual worlds could support. The second generation of virtual environments were introduced to the general public in the U.S. and in Europe by the larger online service providers, including Compuserve, Prestel and CompuNet. These initial commercial offerings proved to be a great success in the US where flat-rate local phone calls were common, allowing gamers to connect to local POPs with zero incremental costs. However throughout the UK and Europe local telephone calls were charged by the minute, resulting in expensive telephone bills. The popularity of these games/virtual environments allowed CompuServe to capture over one million users over a period of three years. Other online services followed suit, with AOL eventually becoming the dominant online service provider in the US, while virtual environments remained a major part of their service offerings.

However, the reliance upon a single distribution channel left many virtual world developers in a vulnerable position that would eventually cause their demise. Many of these free virtual environments had been running variants of TinyMUD developed by Jim Aspnes at Carnegie Mellon University. TinyMUD was one of the first virtual environments to be ported to the Unix operating system that was in turn widely used by universities and large corporations. This resulted in just about anyone with reasonable access permissions to a university or corporate server being able to host their own virtual environment for use by their friends and the general public.

Commercial virtual worlds found a new lease of life with the introduction of Massively Multiplayer Online Games (MMOGs) in 1997, such as used by Origin Systems' “Ultima Online”, and NCSoft's “Linage” products. These two products were based on the world game models as the earlier MUD implementations, but extended these models with a rich 3D interaction model. Rather than describing the virtual environments in text, the MMOGs rendered a graphical representation of those environments in an isometric 3D form. Rather than having to type, e.g. “go north”, a player would just press an arrow on their keyboard and their character or avatar would move or walk in real-time towards the top of their display screen (i.e. virtual north). The rich graphic environment made MMOGs more attractive to the modern user who had become used to the 3D graphical environments offered by contemporary video games.

One of the problems with existing MMOG and virtual world environments is that they do not immerse the user in any meaningful way in that environment, other than for simple game-playing. For example, they do not utilize such features as channels, or buddy lists; nor do they provide environments in which the users of simple messaging clients can easily interact with one another, without a need for extensive changes to those messaging clients or without substantial learning on the part of the user. It is these, and other goals, that the present invention addresses.

### SUMMARY

The invention is generally related to instant messaging systems, online gaming environments, and interactive computing, and is specifically related to systems and methods for integration of instant messaging and virtual environment clients. An objective of the present invention is to provide a means to enable users of existing instant messaging clients to be participate in channel based or conference call like conversations with multiple users simultaneously without compromising the ease of use typically associated with those clients. The core functionality includes the integration of avatars and virtual environments via an external proxy server to manage chat sessions in the external messaging clients. This integration of avatars, virtual environments and messaging clients leverages user experience in real world communications (through the use of a virtual environment) and existing messaging clients to provide a user model that is significantly easier for the average user to understand and utilize. The main integration point between messaging networks and virtual environments is enabled through the linking of user avatars in a virtual environment to a user's instant messaging account. This enables the location of avatars in the virtual environment and the proximity of other avatars to control communication sessions in the external messaging clients.

### BRIEF DESCRIPTION OF THE DRAWINGS

FIG. 1 shows an illustration of an example of a Multi-User Dungeon (MUD) text-based gaming session.

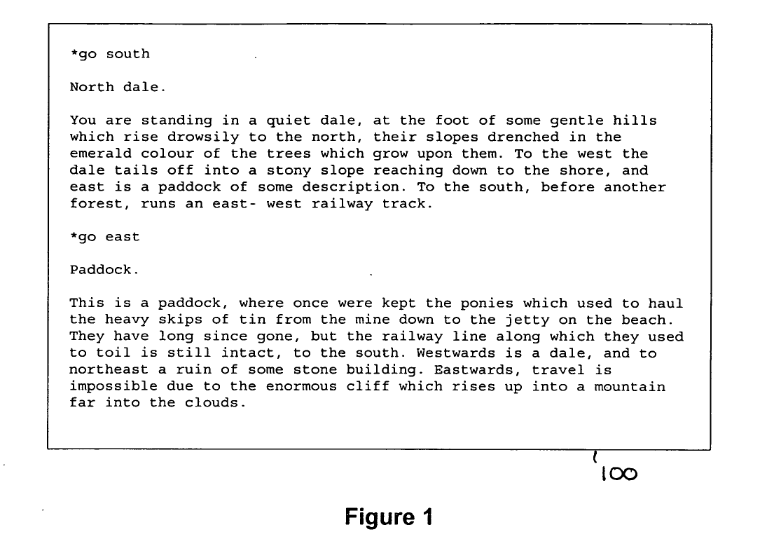

FIG. 2 shows an illustration of a system for integration of instant messaging and virtual environment clients using proxy servers, in accordance with an embodiment of the invention.

FIG. 3 shows a flowchart of a method for integration of instant messaging and virtual environment clients using proxy servers, in accordance with an embodiment of the invention.

FIG. 4 shows an illustration of an implementation of the system for integration of instant messaging and virtual environment clients, in accordance with an embodiment of the invention.

FIG. 5 shows another illustration of an implementation of the system for integration of instant messaging and virtual environment clients, in accordance with an embodiment of the invention.

### DETAILED DESCRIPTION

The invention is generally related to instant messaging systems, online gaming environments, and interactive computing, and is specifically related to systems and methods for integration of instant messaging and virtual environment clients using proxy servers. An objective of the present invention is to provide a means to enable users of existing instant messaging clients to participate in channel based or conference call like conversations with multiple users simultaneously without compromising the ease of use typically associated with those clients. The core functionality includes the integration of avatars and virtual environments via an external Proxy Server to manage chat sessions in the external messaging clients. This integration of avatars, virtual environments and messaging clients leverages user experience in real world communications (through the use of a virtual environment) and existing messaging clients to provide a user model that is significantly easier for the average user to understand and utilize. The main integration point between messaging networks and virtual environments is enabled through the linking of user avatars in a virtual environment to a users messenger account. This enables the location of avatars in the virtual environment and the proximity of other avatars to control communication sessions in the external messaging clients.

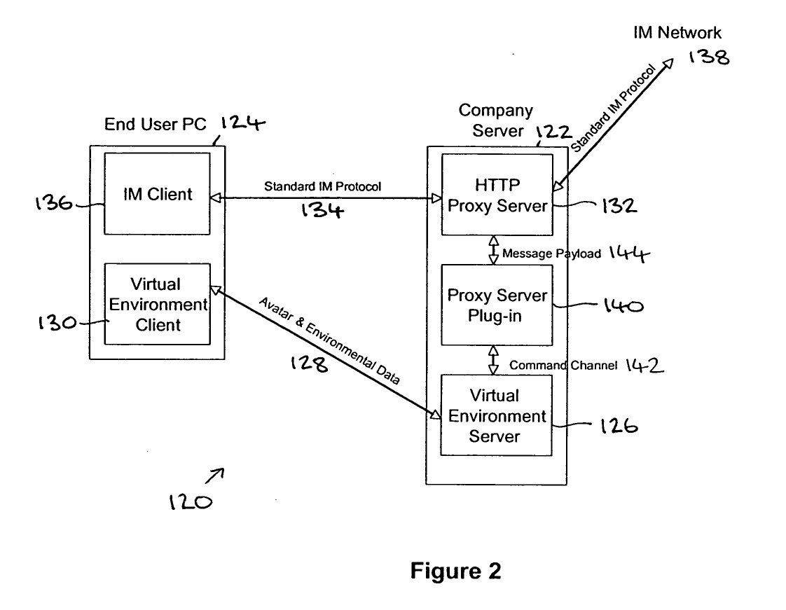

FIG. 2 shows an illustration of a system for integration of instant messaging and virtual environment clients using proxy servers, in accordance with an embodiment of the invention. As shown in FIG. 2, in accordance with an embodiment the system 120 shown therein comprises a virtual environment server 126 and one or a plurality of virtual environment clients 130. The virtual environment server maintains avatar and environment data, and communicates this information 128 to and/or from the virtual environment clients. The avatar information is associated with the locations and the status of the various avatars present within the environment. The system also comprises a proxy server 132 that communicates instant messaging information via an instant messaging protocol 134 to and/or from one or a plurality of instant messaging clients 136, or to other clients on an instant messaging network 138. The instant messaging information is related to the avatars present within the environment. In accordance with an embodiment, a proxy server plug-in 140, inc communication with the virtual environment server via a command channel 142, manages the instant messaging command and control messages 144 passing through the proxy server.

The virtual environment clients are configured to display user avatars and the virtual environment, while the instant messaging clients are configured to communicate with the proxy server. Depending on the particular implementation employed, the virtual environment server, proxy server, and other server processes may be configured to operate as a single component or several components on a single physical machine or company server122, or may span a cluster or network of machines. Similarly depending on the particular implementation, the virtual environment client and the instant messaging client may be configured to operate as a single component or several components on a single machine or end-user computer 124, or may span a cluster or network of machines.

Several of these components are discussed in further detail below:

Virtual Environment Client: The virtual environment client is used to display IM user avatars and the virtual environment. This client also indirectly controls the IM connection status of those IM users who are represented by avatars in the virtual environment.

Instant Messaging (IM) Client: The IM client can be a standard IM client configured to use a proxy server.

Virtual Environment Server: This component serves avatar and environmental data (for example, graphics, object rules, avatar location, etc). The virtual environment server also receives information from the virtual environment client associated with the locations and status of the various avatars present inside this environment. This location and status information is used to manage the IM conversation or connection status for users who are represented by avatars in the virtual environment. For example, in accordance with an embodiment, if two avatars are located in close proximity to each other inside the virtual environment then the virtual environment server will issue a command to the virtual environment proxy to initiate a new IM conversation session between the aforementioned users. During this conversation, if one of the users directs their avatar to move out of close proximity with the other users avatar then the virtual environment server will issue a command to the virtual environment proxy to terminate the IM conversation session.

HTTP Proxy Server: The proxy server (proxy) can be a standard web server (such as the Open Source Apache Server) that provides a plug-in style extensibility model and can be configured to operate as a proxy server.

Proxy Server Plug-in: This component manages the IM command and control messages passing through the HTTP proxy server. While the end-user is using the virtual environment client, the proxy server plug-in intercepts command and control messages (such as a command to initiate an IM session) from the IM client, integrates these messages with IM network-specific translation of commands from the virtual environment server, and then passes them onto the IM network for further processing. The proxy server plug-in may also act as a filter for command and control messages from the IM client if they conflict with commands from the virtual environment server (such as commands to initiate and/or terminate IM sessions). In some embodiments the proxy server can also process the conversational contents of the user IM sessions using a profanity or obscenity filter, to provide a more child-safe virtual environment and IM experience.

Depending on the particular implementation deployed, there are several other approaches and variations to providing the synchronization between IM and the virtual environment, for example:

The use of a virtual network port driver to intercept IM command and control messages before they are transmitted from the end-users machine: In such a system the intercepted messages can be routed to the virtual environment servers and processed in a similar manner to that described above. This approach has the advantage of providing a completely transparent solution in terms of the IM client and IM network. However this approach is also less architecturally elegant, requires the user to install additional software on their machine, and increases the cost of porting (since the virtual network port driver code is by definition operating system-specific);

The use of a proxy server architecture without the usage of separate virtual environment server and virtual environment proxy servers: Instead, the functionality associated with these two components can be integrated into a single component. This approach can potentially provide better performance over one that uses two discrete components on different machines since it can leverage highly efficient (such as pass-by-reference) methods of communicating data inside a single process.

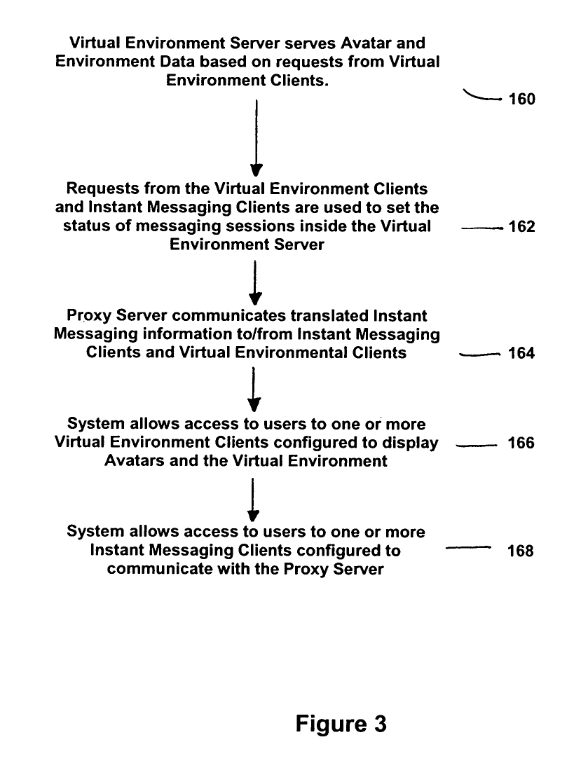

FIG. 3 shows a flowchart of a method for integration of instant messaging and virtual environment clients using proxy servers, in accordance with an embodiment of the invention. As shown in FIG. 3, in step 160, a virtual environment server serves avatar and environment data based on requests from virtual environment clients. This data can be generated from queries to an associated environmental and avatar state database that in turn is integrated with messaging session status provided by the proxy server. In step 162, requests from the virtual environment client and the instant messaging client (received via the proxy server) are used to set the status of messaging sessions inside the virtual environment server. In step 164, the proxy server communicates translated instant messaging information to/from the instant messaging clients and the environmental clients (via the virtual environment server). In step 166, the system allows access to users to one ora plurality of virtual environment clients that are configured to display user avatars and the virtual environment. In step 168, the system allows access to users to one or a plurality of instant messaging clients that are configured to communicate with the proxy server. Depending on the particular implementation the system may include an end-user personal computer with a virtual environment client and instant messaging client located thereon for use by said end user in interacting with the virtual environment. An end-user may be represented by an avatar within the environment and use said virtual environment client and said instant messaging client simultaneously to interact with their avatar and the avatars of other users. The instant messaging client may operate over standard instant messaging protocols. The virtual environment server and the proxy server may communicate via a plugin to relate the avatar information with the instant messaging information.

As described above, depending on the particular implementation employed, the virtual environment server, proxy server, and other server processes may be configured to operate as a single component on a single physical machine or computer, or may span a plurality of such machines. Similarly depending on the particular implementation, the virtual environment client and the instant messaging client may be configured to operate as a single component on a single machine or computer, or may span a plurality of such machines.

Interaction Scenarios

The following use-cases illustrate the types of interaction that can be accomplished with the system. These use-cases are based on a hypothetical text, audio and video chat session between three friends (Andrew, Karyn and Paul), using an Apple Macintosh computer and iChat as their primary messaging client for communication tasks. It will be evident that other computer systems and messaging clients could be utilized.

1. One-on-One Messaging Sessions

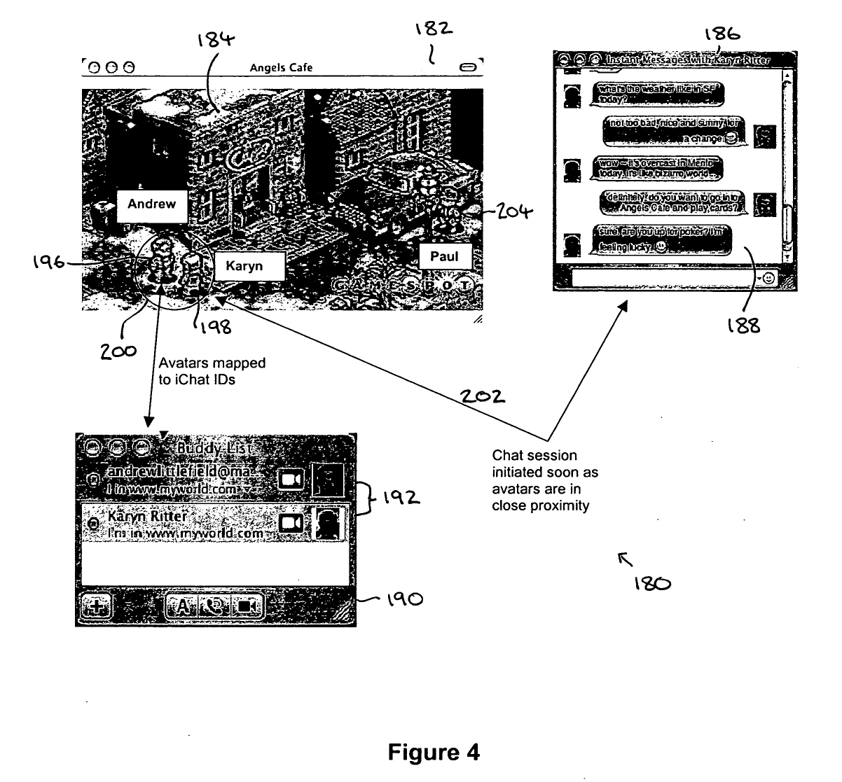

FIG. 4 shows an illustration of an implementation 180 of the system for integration of instant messaging and virtual environment clients, in accordance with an embodiment of the invention. Each user is presented with a display 182 that shows a virtual environment 184 (as provide by the virtual environment client), and a display 186 that shows an instant messaging dialogue 188 (as provided by the instant messaging client). An additional display 190 that shows a person's buddy list may also be provided, wherein the buddy list can be used to provide a mapping 192 between a persons avatar and their user identification. It will be evident that the functionality of each display can be combined in some way to present a common or uniform display window. In this scenario, a first user Andrew 196 wishes to initiate a messenger conversation with a second user Karyn 198. To do this Andrew simply moves his avatar within the virtual environment display so that it is in close proximity 200 to the avatar that represents Karyn. A conversation can then be started 202, and continued within the instant messaging dialogue. If either party wishes to end their conversation then they can move their avatars away so that they are no longer in close proximity.

2. Multi-Party Conference Sessions

In this scenario, a third user Paul 204 wishes to initiate a messenger conversation with both Karyn and Andrew. To do this Paul moves his avatar so that it is in close proximity to the avatars that represent Andrew and Karyn. If any party wishes to end their conversation then they can move their avatars so that they are no longer in close proximity.

The process may be repeated as desired for fourth and subsequent users to create large multi-party conference sessions.

3. Video Conference Sessions

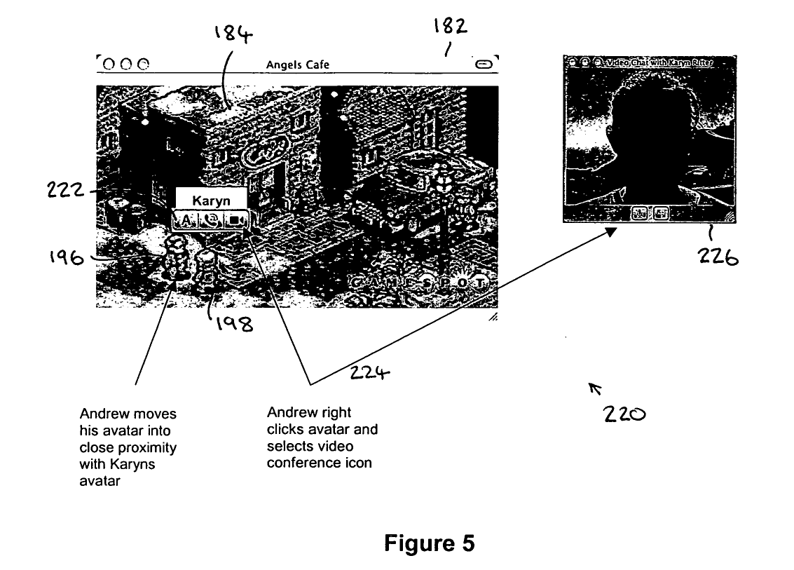

FIG. 5 shows another illustration of an implementation 220 of the system for integration of instant messaging and virtual environment clients, in accordance with an embodiment of the invention. In this scenario, a first user Andrew 196 again wishes to initiate a videoconference with a second (third, or subsequent) user Karyn 198. To accomplish this, Andrew moves his avatar so that it is in close proximity to the avatar that represents Karyn and right-clicks (option-clicks, or otherwise selects) on the avatar that represents Karyn. This right-click action causes an option window 222 to appear above Karyn's avatar that lists the available communication channels associated with Karyn's messenger client (for example, send text message, make telephone call, make video call, etc.). From this list Andrew can select a video icon, and a video conferencing session is automatically initiated between Andrew and Karyn, and displayed in a video window or display. No further user intervention is required.

### INDUSTRIAL APPLICABILITY

In accordance with embodiment of the present invention, users of instant messaging clients can participate in channel-based or conference-call-like conversations with multiple users simultaneously, without compromising the ease of use typically associated with those clients. The system allows for the integration of avatars and virtual environments via an external proxy server to manage chat sessions in the external messaging clients. The integration of avatars, virtual environments and messaging clients leverages real-world user experiences, and existing messaging clients, to provide a user model that is easier for the average user to understand and utilize. An integration point between messaging networks and virtual environments can be enabled through linking a user avatar in a virtual environment to a user's messenger account. This enables the location and proximity of avatars in a virtual environment to control communication sessions in the external messaging clients.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, anytype of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, while a figure may depict components as logically separate, such depiction is merely for illustrative purposes. It will be apparent to those skilled in the art that some or all of the components portrayed can be combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for integration of instant messaging and virtual environment data, comprising:
a virtual environment server that provides access to a virtual environment and to avatars therein, and communicates environment and avatar data to a virtual environment client;
a proxy server in communication with the virtual environment server via a proxy server plugin, that communicates instant messaging information to an instant messaging client using an instant messaging protocol, wherein the instant messaging information is associated with the avatars; and
wherein the system allows a first user, represented by a first avatar in the virtual environment, to communicate with another user, represented by another avatar in the virtual environment, using the instant messaging protocol.

2. The system of claim 1 wherein the virtual environment client and the instant messaging client are located on the same client computer.

3. The system of claim 1 further comprising:
one or more virtual environment clients configured to display user avatars and the virtual environment; and
one or more instant messaging clients configured to communicate with the proxy server.

4. The system of claim 3 wherein the system includes a computer with a virtual environment client and an instant messaging client located thereon for use by the first user in interacting with the virtual environment.

5. The system of claim 4 wherein the first user is represented by an avatar within the environment and uses said virtual environment client and said instant messaging client simultaneously to interact with their avatar and the avatars of other users.

6. The system of claim 1 wherein the instant messaging client operates over one of standard instant messaging protocols.

7. The system of claim 1 wherein additional instant messaging protocols can be supported by the system by adding additional proxy servers and additional proxy server plugins.

8. A method for integration of instant messaging and virtual environment clients, comprising the steps of:
providing a virtual environment server that provides access to a virtual environment and to avatars therein, and communicates environment and avatar data to a virtual environment client;
providing a proxy server in communication with the virtual environment server via a proxy server plugin, that communicates instant messaging information to an instant messaging client using an instant messaging protocol, wherein the instant messaging information is associated with the avatars; and
allowing a first user, represented by a first avatar in the virtual environment, to communicate with another user, represented by another avatar in the virtual environment, using the instant messaging protocol.

9. The method of claim 8 wherein the virtual environment client and the instant messaging client are located on the same client computer.

10. The method of claim 8 further comprising:
providing one or more virtual environment clients configured to display user avatars and the virtual environment; and
providing one or more instant messaging clients configured to communicate with the proxy server.

11. The method of claim 10 including providing a computer with a virtual environment client and an instant messaging client located thereon for use by the first user in interacting with the virtual environment.

12. The method of claim 11 wherein the first user is represented by an avatar within the environment and uses said virtual environment client and said instant messaging client simultaneously to interact with their avatar and the avatars of other users.

13. The method of claim 8 wherein the instant messaging client operates over one of standard instant messaging protocols.

14. The method of claim 8 wherein additional instant messaging protocols can be supported by adding additional proxy servers and additional proxy server plugins.

15. A computer readable medium including instructions stored thereon which when executed cause the computer to perform the steps of:
providing a virtual environment server that provides access to a virtual environment and to avatars therein, and communicates environment and avatar data to a virtual environment client;
providing a proxy server in communication with the virtual environment server via a proxy server plugin, that communicates instant messaging information to an instant messaging client using an instant messaging protocol, wherein the instant messaging information is associated with the avatars; and
allowing a first user, represented by a first avatar in the virtual environment, to communicate with another user, represented by another avatar in the virtual environment, using the instant messaging protocol.
